(19) United States
(12) Patent Application Publication
(10) Pub. No.: US 2002/0065700 A1
(43) Pub. Date: May 30, 2002

(54) METHOD AND SYSTEM FOR ALLOCATING PERSONNEL AND RESOURCES TO EFFICIENTLY COMPLETE DIVERSE WORK ASSIGNMENTS

(76) Inventors: G. EDWARD POWELL, AUSTIN, TX (US); MARK T. LANE, FRANKLIN, TN (US); RUNAR INDSETH, AUSTIN, TX (US)

Correspondence Address: HUGHES & LUCE LLP, 1717 MAIN STREET, SUITE 2800, DALLAS, TX, 75201, US

(21) Appl. No.: 09/294,251

(22) Filed: Apr. 19, 1999

(51) Int. Cl. G06F 17/60

(52) U.S. Cl. 705/9

(57) ABSTRACT

The present invention provides a method for processing multiple work assignments to a mobile workforce having a plurality of mobile workforce members. The steps of this method include receiving a first work assignment. This work assignment is then examined to determine the type of work assignment, a service assignment or a pooled assignment. If the work assignment is a pooled work assignment, the work assignment is placed within a pooled work assignment queue. Similarly, if the work assignment is a service work assignment, that assignment is placed within a service work assignment queue. The process is iterative and additional work assignments may be received and sorted into the proper queue. A schedule may then be created for each individual work force member according to the assignments within the service queue. These scheduled are examined and periods of availability or slack times are identified. These periods of availability or slack time are then filled with work assignments from the pooled queue.

### TECHNICAL FIELD OF THE INVENTION

The present invention relates generally to task management. More specifically, the present invention relates to a system and method for efficiently scheduling service technicians and resources to complete work assignments within a defined geographic area.

### BACKGROUND OF THE INVENTION

The combination of scheduling service appointments and scheduled maintenance (pooled work assignments) presents a problem to any service company. This is particularly true of a utility company, such as one providing electricity, gas, telephone, or cable, and the like, which has a large mobile workforce. These companies must quickly and efficiently respond to ever changing service requests by their customers while efficiently completing pooled work assignments. In such an environment, part of the work that the service technicians perform is directly related to a customer service order, and this work typically takes place at a customer's site.

The service provider, based on experience, must plan the sequence in which the work will be done, and the extent to which resources (workforce members) will be devoted to any particular task. Unforeseen circumstances, such as emergent customer requests and absent employees, may effect this plan with again unforeseen consequences. Such circumstances must be considered by an experienced planner.

Similarly, scheduling in the manufacturing or factory setting is of great importance. Customer orders for various items need to be processed in a certain amount of time (i.e., by a shipment date). For each item ordered which is not already in inventory, the item must be manufactured. To manufacture the item, certain resources (materials, machine time, man hours, etc.) used in a predetermined sequence of events are required. In order to efficiently utilize the resources of the manufacturing plant in such manufacturing of items, and ultimately in fulfilling a multiplicity of orders, the manufacturer generally employs a device for scheduling the use of different resources at different dates and times.

Various scheduling methods exist to aid in and/or optimize such scheduling of resources. One method of scheduling is the critical path method, CPM, in which diagrams depict the stages of a project as nodes, and the duration of the tasks required to reach the successive stages as arrows.

In a variation of CPM, known as PERT, ranges of task duration may also be shown. Additional information, such as cost or number of workers, may be added in the form of text along the arrows or on the nodes of the diagram.

Another technique, linear scheduling, depicts repetitive tasks by a line plotted on a coordinate system in which the horizontal axis represents time, the vertical axis represents location, and the slope of the line represents the projected production rate for the task. However, the methods in themselves are interactive and manually intensive.

Scheduling software is widely used in manufacturing industries to address this problem. The advent of advanced technology in manufacturing systems has highlighted our inability to effectively schedule the production processes. In any production unit, the planner is responsible for making scheduling decisions. Simple scheduling decision rules can affect the system performance to a large extent. Hence, selecting proper scheduling rules is very difficult and such scheduling decisions must often be made in mere seconds.

One of the best approaches to solve these manufacturing scheduling problems have been to use software solutions. Significant manufacturing throughput improvements can be made by using a simulation model to determine a future course for a manufacturing system. Hence, at each scheduling decision point, the scheduling software can be used and a deterministic simulation is run to find out to see how control policy impacts the current system.

Scheduling software helps to generate potential scheduling alternatives based on real-time shop information and scheduling knowledge. However, unlike the service environment, the manufacturing processes themselves are fixed and unchanging once the product has begun to be produced, while the service industry must respond to changing and emergent customer requests.

### SUMMARY OF THE INVENTION

Therefore, there is a need for a method and system to provide advanced planning and scheduling solutions enabling a user or planner to optimize the allocation of his workforce in response to changing service requests and priorities present in the service industry.

There is a need for a software solution enabling a service provider to provide improved customer service and satisfaction, and improved workforce efficiency.

Moreover, there is a need for a software solution allowing a service provider to increase their customer-responsiveness, fostering a reliable and timely service request commitment process, and allowing for better and more accessible information.

Yet another need exists for a software solution which allows a planner to accommodate the multiple skill levels of individuals within a workforce and assign service requests according to the type and coverage requirements. Often an intricate relationship exists between task definition, job requirements, shift scheduling and employees' personal schedules and other preferences, further complicating the planning of work schedules.

Yet another need exists for a software solution which allows a planner to quickly and efficiently create schedules that meet employee preferences and still provide coverage, thereby reducing absenteeism, improving workforce morale, and allowing overtime expenses to be reduced.

In particular, a need exists for a method and system that provides for efficiently scheduling service technicians and resources to complete service and pooled work assignments within a defined geographic area.

In accordance with the present invention, a system and method is provided for scheduling multiple work assignments of diverse types and requirements to a mobile workforce.

More specifically, the present invention provides a method for processing multiple work assignments of diverse types to a mobile workforce having a plurality of mobile workforce members. The steps of this method include receiving a first work assignment. This work assignment is examined to determine the type of work assignment, a service assignment or a pooled assignment. If the work assignment is a pooled work assignment, the work assignment is placed within a pooled work assignment queue. Similarly, if the work assignment is a service work assignment, that assignment is placed within a service work assignment queue. The process is iterative. Subsequent work assignments may be received and sorted into the proper queue according to their type. A schedule may be created for the work force as a whole and each individual work force member according to the assignments within the service queue. These schedules are examined for periods of availability or slack time. Once identified, these periods of availability or slack time are than filled with work assignments from the pooled queue.

The method of this invention further includes repeating the step of processing subsequent and emergent work assignment which may impact work force schedules. The method of this invention can process any number of additional and emergent work assignments to create and distribute modified schedules to members of the workforce at any given point in time limited only by the capability of the workforce.

A technical advantage provided by the method of the present invention provides advanced planning and scheduling solutions enabling a service provider to optimize the allocation of his workforce in response to the changing service requests and priorities present in the service industry.

Another technical advantage of the present invention is the capability to provide improved customer service and satisfaction, and improved workforce efficiency. This is accomplished by allowing the planner to effectively communicate revised customer needs to the workforce, and in turn the expected workforce response to the customer. The present invention allows service providers to increase their customer-responsiveness, fostering a reliable and timely service request commitment process, and allowing for better and more accessible information.

A further technical advantage of the present invention is the capability of providing a scheduling solution which allows a planner to accommodate the multiple skill levels of individuals within a workforce and assign service requests according to the required skill level requirements. Often an intricate relationship exists between task definition, job requirements, shift scheduling and employees' personal schedules and other preferences. These intricate relationships have previously complicated the efficient planning of work schedules encompassing diverse workforces and assignments.

A still further technical advantage of the present invention is the ability of service providers to quickly and efficiently create schedules that meet employee preferences and still provide coverage, thereby reducing absenteeism, improving workforce morale, and allowing overtime expenses to be reduced. Furthermore, the present invention reduces the man hours spent trying to create workable schedules by using the computational power of a computer. A user can quickly generate an efficient schedule which fairly distributes assignments among employees with user-prioritized rules.

Still another technical advantage of the present invention allows the service provider to determine manpower requirements. This is accomplished by examining both past allocations of resources and expected future needs enabling the user to achieve a fair distribution or cost effective distribution of manpower.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 shows a simplified flow chart illustrating one embodiment of the method of the present invention for scheduling multiple tasks;

FIG. 2 illustrates the scheduling problem addressed by the present invention;

FIG. 3 provides a detailed flow chart of one embodiment of the method of the present invention;

FIG. 4 shows the assignment of a work assignment to a service queue within the method of the present invention;

FIG. 5 shows the assignment of a work assignment to a pooled work queue within the method of the present invention; and

FIG. 6 provides a diagram of a computer system to implement the method of the present invention.

### DETAILED DESCRIPTION OF THE INVENTION

Preferred embodiments of the present invention are illustrated in the figures, like numerals being used to refer to like and corresponding parts of various drawings.

The present invention provides a method for processing multiple diverse work assignments to a mobile workforce having a number of mobile workforce members. The steps of this method include receiving a first work assignment. This work assignment is then examined to determine the type of work assignment, a service assignment or a pooled assignment. If the work assignment is a pooled work assignment, the work assignment is placed within a pooled work assignment queue. Similarly, if the work assignment is a service work assignment, that work assignment is placed within a service work assignment queue. The process is iterative and additional work assignments may be received and sorted into their proper queue. A schedule may then be created for the work force as a whole and each individual work force member according to the assignments within the service queue. These schedules are examined and periods of availability or slack time are identified. These periods of availability or slack time are then filled with work assignments from the pooled queue.

Work that takes place at a customer site is committed to by the company to be performed that day. Pooled work is only governed by its due date, which determines how important it is to be done today.

Pooled work is a type of work that a mobile workforce will perform that is not related to any particular customer or service order. For a utility company, this work can include walking a gas pipeline to check for leaks, climbing utility poles, and checking cables and other company-owned hardware in the field. This work can be categorized by priorities, and some of the lower priority work is such that it can be performed anytime within a specified period. As the deadline for a pooled work task approach, the individual task may increase in priority. Most of the mobile workforce must share in the responsibility of completing the pooled work tasks. The orderly completion of those tasks is a daunting scheduling problem. Often these tasks require unnecessary overtime expenses due to inefficient scheduling, while keeping up with the demands of the service orders that must be performed on a particular day, to ensure timely completion due to scheduling problems. This problem can pose a combinatorial challenge, given all of the pooled work orders that must be performed, the number of different places that the work can be performed, and the number of possibilities for service technicians to perform these tasks.

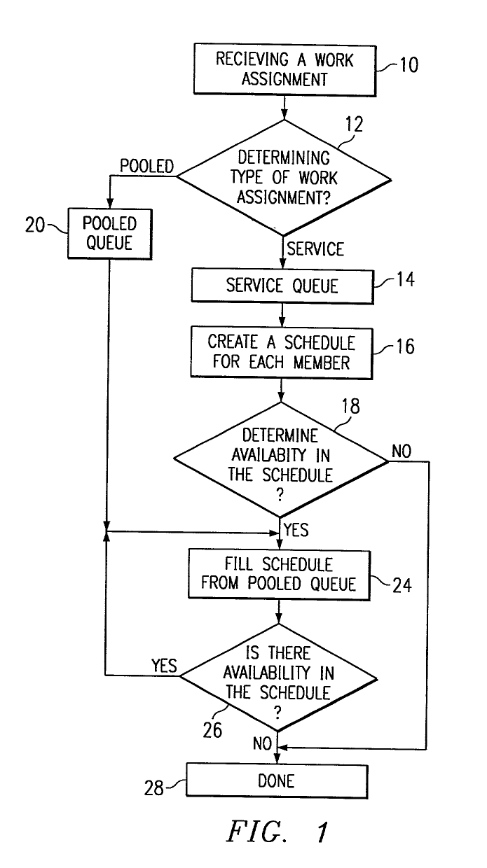

FIG. 1 shows a flow chart of one embodiment of the operational steps according to the teaching of the present invention. This flow chart diagrams the overall operation of the method for processing multiple work assignments to a mobile workforce. This method can be implemented manually or by using a software solution which takes advantage of the computational power of a computer. At step 10 of FIG. 1, the method of the present invention receives a work assignment or work request.

In step 12, a determination is made as to the nature or type of work assignment. In one embodiment the service providers often perform many diverse functions. For example, the work assignment may be a service work assignment, wherein a workforce member is interacting directly with a customer or going to a customer's site. If the assignment is a service work assignment, the assignment is placed in a service queue at step 14. Another possible type of work assignment is a pooled work assignment wherein the assignment is placed in a pooled queue at step 20.

A schedule for each workforce member can then be created based on the work assignments in the service queue 14 at step 16 of the method of the present invention. This scheduling process may reflect time constraints imposed by customers, skill level requirements, geographic limitations, or employee preferences.

After an initial service schedule has been created for each workforce member in step 16, these schedules are examined to determine whether or not there are any periods of availability or slack time within the individual workforce member schedules at step 18. In an embodiment employing the use of a computer, a scheduling or optimization engine may be used to make this determination. These periods of availability or slack time include any unnecessary waiting or time that is available within a workforce member shift.

This scheduling and optimization engine may be defined as a software object that performs scheduling and optimization functions for a series of events within a database. The scheduling and optimization engine itself is a powerful software object that examines a database containing the scheduling data input and rules. This software object can then create a schedule based on both the data input and rules which it applies to this data. Optimization routines are incorporated into the rules to create and revise existing schedules in real time. The data input provided to the engine includes work assignments, workforce abilities, preferences, geographic locations, priorities, time windows and the like. The rules instruct the engine how to sort and prioritize different work assignments. Further, the rules also allow workforce abilities and preferences to be correlated to individual work assignments in the scheduling process.

It is to the service provider's advantage not to over-schedule every workforce member wherein no slack time exists within the workforce. If the mobile workforce is over-scheduled for the day with customer service orders, then either contract employees will have to be brought in to perform pooled work at increased expense or lower-priority work will be sacrificed until another day. Furthermore, the work force will be unable to address emergent requests or actual emergencies.

In order to provide optimal scheduling, the slack time or periods of availability are filled with pooled work orders at step 24. These pooled work orders can easily be replaced with higher-priority customer service requests or emergency service work throughout the day, providing some flexibility within utilization of the workforce.

In step 20, all of the outstanding pooled work orders for a particular day are organized by priority, required skills and geographic location. The method of the present invention divides the geographic area served by the service provider into smaller areas or geographic blocks. Each geographic block has fewer pooled work orders than would exist in larger areas. When it comes time to look at the individual pooled work orders, neighboring geographic blocks can be merged if necessary. In an embodiment utilizing a computer, the functions in step 20 and 24 are accomplished with a scheduling or optimization engine.

In step 24, the slack time or periods of availability are filled from the pooled queue 20. At each point throughout a workforce member's daily schedule, the method of the present invention will consider the workforce member's geographic location and associate a geographic block with that location. This allows travel time between consecutive work assignments to be minimized, ensuring efficient overall use of the workforce as a whole. Pooled work orders associated with those geographic blocks may be inserted according to the priority of each pooled work order. After a pooled work order has been inserted into the individual workforce member's schedule, a second determination of slack time or periods of availability is made in step 26. If slack time or periods of availability remain, the pooled queue at step 20 is again queried in order to fill the schedule at step 24. This process is iterative until all slack time is filled. If no pooled work requests are present in the geographic blocks, the search for pooled work requests may be expanded to adjacent geographic blocks. This limitation reduces the number of pooled work requests which must be examined thus increasing the overall efficiency of the method of the present invention.

As the process proceeds, it is not always possible to insert work orders from specific geographic blocks into a work force member schedule. This inability can be due to time commitments or skill levels associated with individual work requests. This can also be caused by the inability of the work force to complete the assignments without overtime. Therefore, the method of the present invention looks at the entire workforce scheduling problem as a whole, before deciding where pooled work orders can be inserted. Because the number of pooled work orders in an individual geographic block should be small, the intermediate calculations will not be computationally intensive. This limitation increases the speed and simplicity of the method of the present invention. If not enough pooled work orders are present in the geographic blocks along the path of the workforce member's service schedule, the process can be expanded to consider pooled work requests from neighboring geographic blocks. This process is reiterated until there are no periods of availability or slack time within the schedule of an individual workforce member or until no pooled work orders exist.

There are three fundamental issues for the scheduling or optimization engine to consider when attempting to insert a pooled work order into a provider's daily schedule: (1) What priority do the pooled-work orders have, in relation to the other service jobs and to each other? (2) What workforce members have slack in their schedule to allow time for pooled work orders? (3) Where are the pooled work orders located, and where can they be best inserted? The method of the present invention outlines a provider-based localization of the pooled work allocation problem. This problem can be a combinatorial burden on the CPU, and therefore, a smarter method is required other than one specifying exhaustive brute-force trial and error. The first task is to organize all of the outstanding pooled work orders for a particular day by priority and geographical distribution.

When pooled work orders are to be inserted into an individual provider's schedule, it is necessary to look for slack time. Slack time is the unnecessary waiting or time that is available that is not scheduled. At this stage, it is to the service providers' advantage to not over-schedule every member of the workforce, so that there is little or no slack time in the schedules. If the mobile workforce is over-subscribed for the day doing customer service orders, then either contract employees will have to be brought in to perform the pooled work, or else the lower priority work will be sacrificed until another day. An attractive advantage to filling pooled work orders into slack time is that these orders can be easily replaced with higher priority and emergency service work throughout the day, such as servicing emergency gas leaks in the example of a gas utility. However, the present invention is not aimed at scheduling emergency services, but rather the optimal and efficient assignment of diverse work assignments into a schedule (before emergency or unforeseen work is known).

For every workforce member with slack time, the following pseudo-code describes an iterative algorithm that will be used to insert pooled work orders into the schedule:

Loop through all of the service points in the schedule.

At each one, consider the provider's geographical location to determine a grid block.

Insert all work pooling orders in that same grid block, and keep the one with the best score, taking into account the priority of each pooled work order.

Repeat the iteration, until the schedule is full.

As the process continues, pooled work orders will not always be able to be inserted at specific junctions in the schedule. This can be due to scheduling conflicts caused by service order appointments. Additionally, these pooled work orders may cause a workforce member to work overtime. Therefore, this process looks at the entire scheduling problem in light of the entire work force as a whole before deciding where pooled work orders can be inserted.

Since the number of work pooling orders in each grid block is small, the intermediate calculations will not be computationally intensive. As mentioned above, the algorithm allows for expansion if not enough work pooling orders are being inserted. Instead of looking at one grid block at a time, the algorithm could use neighboring blocks of 4 or 9, etc. to expand the area where pooled work orders are considered.

The problem and solution are illustrated in FIG. 2. FIG. 2 shows the scheduling problem addressed by the method of the present invention. A geographical area 30 is parsed into smaller areas, grid blocks 31. The solid lines 38 depict a looped schedule through service orders 34 before insertion of the pooled work orders 36. The circle shapes 36 denote the pooled work locations. The diamonds 34 denote the service order (customer) locations. The method of the present invention inserts pooled work orders 36 into the workforce member schedules, creating a revised schedule or route 40. The dotted lines 40 depict the amended schedules after the process of optimally inserting the pooled work orders 36. However, not all pooled work orders 36 are inserted into the optimized schedule. These uncompleted pooled work orders 36 either must be left for: (1) another workforce member, (2) another day, or (3) service by contract providers that are specially called into work.

The table below identifies the differences between the past methodology and the method of the present invention.

| Random Allocation of | |
|---|---|
| Pooled Work | Intelligent Allocation of Pooled Work |
| No Visibility as to Impact of | Automatic Insertion of Pooled work |
| Inserting Pooled Work | with visibility |
| Driving Times within Schedules | Driving Times within Schedules |
| not optimal | optimal |
| Employee Preferences Not | Employee Preferences Considered |
| Considered | |
| Service Order Appointments | Pooled Work Allocation Regards |
| Difficult Manage | Appointments |
| Pooled Work Difficult to Track | Pooled Work Easy to Track in a |
| Priorities | historical database for future analysis |
| Completion Schedules and | Priorities |
| Organization | Completion in Optimal Manner |
| Geographical Distribution | Geographical Distribution and |
| | Organization |

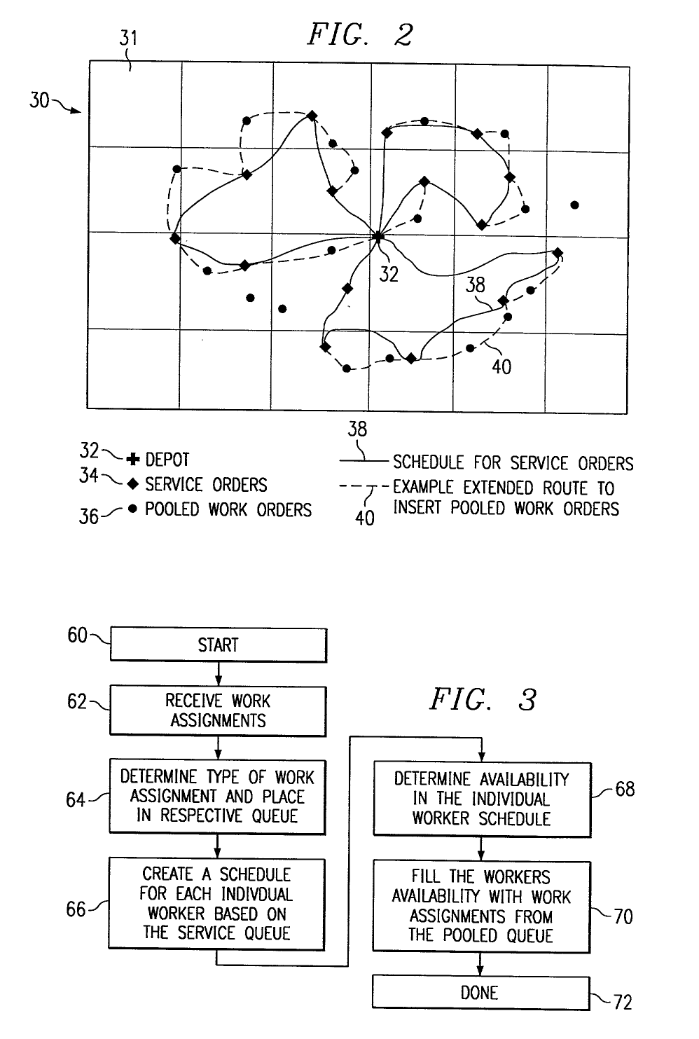

The method of the present invention is further described with the flow diagrams of FIG. 3 through FIG. 5. The process starts at step 60 of the present invention in FIG. 3. Daily work assignments are received at step 62. A determination of the type of work assignment is made in step 64. These work assignments are then placed in either a pooled queue or a service request queue.

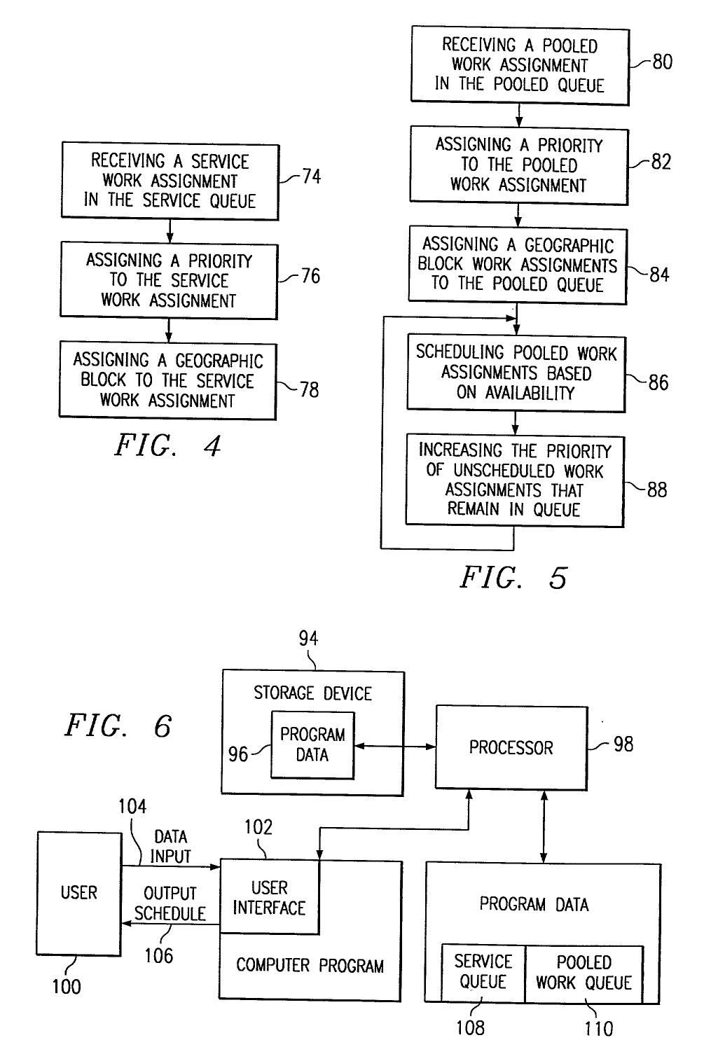

FIG. 4 details the placement of a work request or service work assignment in the service queue.

Starting with step 74, a service work assignment is received in the service queue. Next, a priority to the service work assignment is assigned at step 76. Furthermore, a geographic location or block for the service work assignment is assigned at step 78. Additionally, required skills and time windows may be assigned to the service work assignment. These service work assignments may contain time windows which have been provided to the customer and directly impact customer services. Appointment time windows are considered for scheduling purposes.

The pooled work assignments are examined in FIG. 5. At step 80, a pooled work assignment is received in the pooled queue. Again, a priority is assigned to the individual pooled work assignment at step 82. This priority may increase over time, as a pooled work assignment may have a requirement to be completed by a specific date. Next, a geographic location or block is assigned to the work assignments of the pooled queue. Additionally, required skills and time requirements unique to the work assignment may be assigned to the pooled work assignee.

Returning to FIG. 3, the method of the present invention will create a schedule for each individual workforce member, looping service work assignments from the service queue at step 66. Additionally, workforce member preferences may be used in developing looping service work assignment. At step 68, a determination is made as to periods of availability or slack time in the individual workforce member's schedule. These periods of availability or slack time are filled with work assignments from the pooled queue at step 70, as illustrated in FIG. 3, or steps 86 and 88, as illustrated in FIG. 5, wherein at step 86 the method of the present invention schedules pooled work assignments based on the availability of the individual workforce member.

Incomplete or unscheduled pooled work assignments may be of increasing priority in the queue until they are completed, as illustrated in step 88 of FIG. 5. For example, some routine maintenance functions may be required to be completed on a quarterly basis. At the beginning of a quarter, the priority for these maintenance items may be relatively low and hence they may go unscheduled. As the quarter progresses, the priority of these work assignments will increase to ensure that they are scheduled as necessary. However, in an additional embodiment upon reaching a critical priority, a planner may be alerted that overtime expenses may be authorized or incurred to ensure the proper completion of these pooled work assignments.

At step 72, when there is no availability associated with the individual workforce member's schedule, the scheduling process is complete for that individual workforce.

The method of the present invention allows a planner or scheduler to quickly alter and distribute new schedules to individual members of the workforce when unforeseen circumstances such as emergent work requests arise, forcing a change in the workforce schedule.

The method of the present invention ensures that, despite the changing schedule, the workforce is used efficiently and effectively to respond to such changes.

In an additional embodiment of the present invention, the method of the present invention may be effected by a computer system 90 directed by a computer program 92 operable to schedule diverse work assignments. The computer system will include a storage device 94 containing memory operable to store program data 96 and the computer program 92 itself. The storage device will be coupled to a processor 98. The processor will execute the computer program 92 such that the computer system 90 is directed by the computer program 92 to schedule the diverse work assignments for a mobile workforce.

The computer program 92 will execute the method of the present invention as follows. A user 100 will input a first work assignment 104 as provided by step 10 of FIG. 1 via a user interface 102. Based on a tag or other identifier assigned to the work assignment 104, the computer program 92 will identify the nature or type of the work assignment 104 as illustrated by step 12. In the present embodiment the work assignment 104 is classified as either a service work assignment and placed in a service queue 106 or a pooled work assignment and placed in a pooled queue 108 at step 20.

The computer program 92 will direct that the service work assignments be stored within a memory location allocated to contain each type of queue.

Considering the contents of the service queue, an initial schedule for each workforce member can then be created by the computer program 92 at step 16.

After an initial service schedule has been created for each workforce member in step 16, these schedules are examined by the computer program 92 to determine whether or not there are any periods of availability or slack time within the individual workforce member's schedule at step 18.

To provide optimal scheduling, the computer program 92 will iteratively revise the workforce member schedule by filling the slack time or periods of availability with pooled work orders.

As these revisions are accomplished using computer program 92, the workforce member schedules 106 can easily be revised in real time by replacing pooled work assignments with higher-priority customer service requests or emergency service work throughout the day, providing some flexibility within utilization of the workforce.

The computer program 92 will sort all outstanding pooled work orders for a particular day by priority and geographic location. Computational requirements of the present invention are limited if the geographic area serviced by the mobile workforce is broken into smaller areas or geographic blocks such that each geographic block has fewer pooled work orders than would exist in larger areas. This greatly reduces the number of possible permutations and available combinations. Hence, permitting probable schedules to be quickly evaluated by the computer program 92. If no pooled work orders exist in a geographic block, neighboring geographic blocks can be merged if necessary. Because the number of pooled work orders in an individual geographic block should be small, the intermediate calculations will not be computationally intensive, therefore increasing the speed and simplicity of the method of the present invention. This limitation reduces the number of pooled work requests which must be examined thus increasing the overall efficiency of the method of the present invention.

In iteratively filling the slack time within an individual schedule, the computer program will examine at each point throughout a workforce member's daily schedule, the workforce member's geographic location and geographic block associated with that location. This allows travel time between work assignments to be minimized, ensuring efficient overall use of the workforce as a whole. Pooled work orders associated with those geographic blocks may be inserted according to the priority of each pooled work order.

As the process proceeds, it is not always possible to insert work orders from specific geographic blocks in the schedule. This can be due to commitments associated with work order requests or causing an individual workforce member to work extra overtime. Therefore, the computer program allows a user to schedule the entire workforce as a whole, before deciding where pooled work orders can be inserted. If not enough pooled work orders are present in the geographic blocks along the path of the workforce member's service schedule, the process can be expanded to consider pooled work requests from neighboring geographic blocks. This process is reiterated until there are no periods of availability or slack time within the schedule of an individual workforce member or until no pooled work orders exist.

In summary, the present invention provides a method and system for allocating personnel and resources to efficiently complete work assignments that efficiently schedule mobile service technicians to complete diverse types of work assignments within a defined geographic area.

The present invention provides a method for processing multiple work assignments to a mobile workforce having a plurality of mobile workforce members. The steps of this method include receiving a first work assignment. This work assignment is then examined to determine the type of work assignment, a service assignment or a pooled assignment. If the work assignment is a pooled work assignment, the work assignment is placed within a pooled work assignment queue. Similarly, if the work assignment is a service work assignment, that assignment is placed within a service work assignment queue. The process is iterative and additional work assignments may be received and sorted into the proper queue. A schedule may then be created for each individual work force member according to the assignments within the service queue. These schedules are examined and periods of availability or slack time are identified. These periods of availability or slack time are than filled with work assignments from the pooled queue.

The method of the present invention provides advanced planning and scheduling software solutions enabling a user or planner to optimize the allocation of his workforce in response to the changing service requests and priorities present in the service industry. This allows the user to provide improved customer service and satisfaction, and improved workforce efficiency. This is accomplished by allowing the user to effectively communicate revised customer needs to the workforce and the expected workforce response to the customer. The present invention allows the user to increase their customer-responsiveness, fostering a reliable and timely service request commitment process, and allowing for better and more accessible information.

Furthermore, the present invention provides a software solution which allows a user to accommodate and effectively utilize skill levels of individuals within a workforce and assign service requests according to required skills. Often an intricate relationship exists between task definition, job requirements, shift scheduling and employees personal schedules and other preferences, further complicating the planning of work schedules.

The present invention allows the user to quickly and efficiently create schedules that meet employee preferences and still provide customer coverage, thereby reducing absenteeism, improving workforce morale, and allowing overtime expenses to be reduced. Furthermore the present invention reduces the man hours spent trying create a workable schedule by using the computational power of a computer. A user can quickly generate an efficient schedule which fairly distributes assignments among employees with user-prioritized rules.

The present invention allows the service provider to determine manpower requirements. This is accomplished by examining both past allocations of resources and expected future needs enabling the user to achieve a fair distribution or cost effective distribution of manpower. The present invention provides those work force members already working in the pooled work order locality are considered first, thus minimizing travel times. This is accomplished again by examining the entire daily schedule for the work force when allocating pooled work to providers.

The completion of pooled work orders is efficiently tracked and prioritized determining which orders are inserted before others.

Providers can specify skills and work preferences that are taken into account when allocating pooled work orders to the schedules. To improve customer service, appointment time windows are considered in the scoring model so as not to allow inserted pooled work to cause unnecessary late or overtime.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. A method for processing work assignments of diverse types to a workforce having a plurality of members, wherein the method is accomplished with a scheduling software engine, comprising the steps of:
receiving a first work assignment;
determining a type for the first work assignment;
creating a type queue for each diverse type of work assignment wherein a priority is assigned to each type queue;
placing the first work assignment in the type queue corresponding to the type of the first work assignment;
processing a subsequent work assignment as the first work assignment;
creating a schedule for each workforce member based on the type queue which has a highest priority;
determining availability in the schedule for each workforce member; and
assigning work assignment of a different type from a type queue having a next highest priority within the availability in the schedule for each mobile workforce member from the type queue having the next highest priority.

2. The method of claim 1, further comprising:
dividing an area to be serviced by the workforce into a grid of smaller blocks;
assigning to each work assignment a priority;
assigning to each work assignment a smaller block; and
ordering the work assignments placed in their type queue according to their priority within the type queue.

3. The method of claim 2, further comprising:
assigning to each work assignment a required skill level;
assigning to each workforce member a skill level; and
only scheduling those workforce members having a skill level equal to or greater than the required skill level to each work assignment.

4. The method of claim 2, wherein the step of creating a schedule for each individual workforce member further comprises looping the work assignments in the type queue which has a highest priority to create an optimized loop of work assignments for each workforce member.

5. The method of claim 4, wherein the step of assigning work assignments comprises:
determining which work assignments from the next highest priority queue can be completed within the availability of the workforce member and retaining those work assignments in a first group;
scheduling the work assignments from the first group for an individual workforce member until there is no availability within the individual workforce member schedule; and
reiterating the above steps until there are no work assignments within the first group.

6. The method of claim 5, further comprising:
retaining work assignments within the first group according to a user-defined priority assigned to the work assignment.

7. The method of claim 5, wherein the priority of the work assignments within the first group is increased until the work assignment is completed.

8. The method of claim 7, wherein the work assignments from the first group can be removed from the schedule and replaced by emergent work assignments from the type queue having the highest priority.

9. The method of claim 2, further comprising:
receiving subsequent work assignments;
reiterating the steps of processing the work assignment wherein current workforce member schedules are evaluated and revised if necessary; and
distributing the revised workforce member schedules to the workforce members.

10. A method for processing a plurality of work assignments to a mobile workforce having a plurality of mobile workforce members, comprising the steps of:
receiving a first work assignment;
determining if the first work assignment is a service assignment or a pooled assignment;
placing the service assignment in a service queue;
placing the pooled assignment in a pooled queue; processing a subsequent work assignment as the first work assignment;
creating a schedule for each mobile workforce member based on the service queue;
determining periods of availability in the schedule for each mobile workforce member; and
assigning pooled work assignment where there are periods of availability in the schedule for each mobile workforce member from the pooled queue.

11. The method of claim 10, further comprising:
dividing a geographic location to be serviced by the mobile workforce into a grid of smaller geographic blocks;
assigning to each work assignment a priority;
assigning to each work assignment a geographic block; and
ordering the work assignments placed in the service queue and the pooled queue according to their priority.

12. The method of claim 11, further comprising:
assigning to each work assignment a required skill level; and
assigning to each mobile workforce member a skill level.

13. The method of claim 11, wherein the step of creating a schedule for each individual workforce member further comprises looping the service work assignments in the service queue to create an optimized geographic loop for each mobile workforce member comprising a path of geographic blocks.

14. The method of claim 13, wherein the step of assigning pooled work assignments comprises:
determining which pooled work assignments can be completed within the availability of the workforce member;
retaining pooled work assignments in a first group which are in the geographic blocks forming the path of the looping service work assignments;
scheduling the pooled work assignments from the first group for an individual workforce member until there are no periods of availability within the individual workforce member's schedule; and
reiterating the above steps until there are no pooled work assignments with the first group.

15. The method of claim 14, further comprising:
retaining pooled work assignments within the first group according to a user-defined priority assigned to the work assignment; and
retaining poled work assignments within the first group that are located in geographic blocks adjacent to those blocks forming the path of the service work assignments.

16. The method of claim 14, wherein the priority of the pooled work assignments is increased until the work assignment is completed.

17. The method of claim 15, wherein the pooled work assignments can be removed from the schedule and replaced by an emergent service work assignment.

18. The method of claim 11, further comprising:
receiving subsequent work assignments;
reiterating the steps of processing the work assignment wherein current workforce member schedules are evaluated and revised if necessary; and
distributing the revised workforce member schedules to the workforce members.

19. The method of claim 18, wherein the subsequent work assignment is an emergency work assignment.

20. A computer system directed by a computer program operable to schedule a plurality of diverse work assignments, the computer system comprising:
a storage device operable to store program data;
a memory operable to store a computer program;
a processor coupled to the storage device and the memory, the processor operable to execute the computer program such that the computer is directed by the computer program to schedule the plurality of diverse work assignments for a mobile workforce having a plurality of mobile workforce members;
receive a first work assignment;
determine if the first work assignment is a service assignment or a pooled assignment;
place the service assignment in a service queue;
place the pooled assignment in a pooled queue;
receive and process a subsequent work assignment as the first work assignment;
create a schedule for each mobile workforce member based on the work assignments in the service queue;
determine the availability in the schedule for each mobile workforce member;
assign work assignments in the pooled queue to individual workforce members;
a communication system to distribute a work assignment schedule to the workforce members; and
a user interface used by the user to a access the computer program wherein the user may enter subsequent work assignments and workforce member schedules.

21. The computer system of claim 20, wherein the computer system is further directed by the computer program to:
divide a geographic area to be serviced by the mobile workforce into a grid of smaller geographic blocks;
assign to each work assignment a priority;
assign to each work assignment a geographic block; and
order the work assignments placed in the service queue and the pooled queue according to their priority.

22. The computer system of claim 21, wherein the computer system is further directed by the computer program to:
loop the work assignments in a queue to create an optimized geographic loop for each mobile workforce member comprising a path of geographic blocks.

23. The computer system of claim 22, wherein the computer system is further directed by the computer program to:
determine which pooled work assignments can be completed within the availability period of the workforce member;
place these pooled work assignments within an available queue for the workforce member;
retain pooled work assignments in the available queue which are in the geographic blocks forming the path of the looping service work assignments; and
schedule the pooled work assignments for the individual workforce member from the available queue until there are no periods of availability.

24. The computer system of claim 23, wherein the computer system is further directed by the computer program to:
retain pooled work assignments within the available queue according to a user-defined priority assigned to the work assignment; and
retain pooled work assignments within the available queue that are located in geographic blocks adjacent to those blocks forming the path of the service work assignments.

25. The computer system of claim 22, wherein the computer system is further directed by the computer program to:
increase the priority of the pooled work assignments until the work assignment is completed.

26. The computer system of claim 23, wherein the computer system is further directed by the computer program to:
remove pooled work assignments from the schedule when an emergent service work assignments is placed in the service queue.

27. A method for processing work assignments of diverse types to a workforce having a plurality of members, comprising the steps of:
receiving a first work assignment;
determining a type for the first work assignment;
creating a type queue for each diverse type of work assignment wherein a priority is assigned to each type queue;
placing the first work assignment in the type queue corresponding to the type of the first work assignment;
processing a subsequent work assignment as the first work assignment;
creating a schedule for each workforce member based on the type queue which has a highest priority;
determining availability in the schedule for each workforce member; and
assigning work assignment of a different type from a type queue having a next highest priority within the availability in the schedule for each mobile workforce member from the type queue having the next highest priority.

28. The method of claim 27, further comprising:
dividing an area to be serviced by the workforce into a grid of smaller blocks;
assigning to each work assignment a priority;
assigning to each work assignment a smaller block; and
ordering the work assignments placed in their type queue according to their priority within the type queue.

29. The method of claim 28, further comprising:
assigning to each work assignment a required skill level;
assigning to each workforce member a skill level; and
only scheduling those workforce members having a skill level equal to or greater than the required skill level to each work assignment.

30. The method of claim 28, wherein the step of creating a schedule for each individual workforce member further comprises looping the work assignments in the type queue which has a highest priority to create an optimized loop of work assignments for each workforce member.

31. The method of claim 30, wherein the step of assigning work assignments comprises:
determining which work assignments from the next highest priority queue can be completed within the availability of the workforce member and retaining those work assignments in a first group;
scheduling the work assignments from the first group for an individual workforce member until there is no availability within the individual workforce member schedule; and
reiterating the above steps until there are no work assignments within the first group.

32. The method of claim 31, further comprising:
retaining work assignments within the first group according to a user-defined priority assigned to the work assignment.

33. The method of claim 31, wherein the priority of the work assignments within the first group is increased until the work assignment is completed.

34. The method of claim 33, wherein the work assignments from the first group can be removed from the schedule and replaced by emergent work assignments from the type queue having the highest priority.

35. The method of claim 28, further comprising:
receiving subsequent work assignments;
reiterating the steps of processing the work assignment wherein current workforce member schedules are evaluated and revised if necessary; and
distributing the revised workforce member schedules to the workforce members.
